(19) United States
(12) Patent Application Publication
(10) Pub. No.: US 2010/0264888 A1
(43) Pub. Date: Oct. 21, 2010

(54) DC/DC CONVERTER AND POWER SUPPLY SYSTEM

(75) Inventor: Masaharu Wada, Yokohama-shi (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/648,866

(22) Filed: Dec. 29, 2009

(30) Foreign Application Priority Data
Apr. 20, 2009 (JP) 2009-101998

(51) Int. Cl. G05F 1/59

(52) U.S. Cl. 323/274

(57) ABSTRACT

A DC/DC converter includes a first regulator supplied with a first reference potential, the first regulator outputting an output potential from an output terminal thereof, the first regulator controlling the output potential so as to be equal to the first reference potential; a second regulator supplied with a second reference potential, the second reference potential being lower than the first reference potential, an output terminal of the second regulator being connected to the output terminal of the first regulator, the second regulator controlling the output potential so as to be equal to the second reference potential; and a first comparator which compares a third reference potential and the output potential, the third reference potential being a potential between the first reference potential and the second reference potential, the first comparator putting the second regulator into an operating state under a first condition in which the output potential is lower than the third reference potential, the first comparator putting the second regulator into a stopped state under a second condition in which the output potential is higher than the third reference potential.

### CROSS REFERENCE TO RELATED APPLICATIONS

This application is based upon and claims the benefit of priority from the prior Japanese Patent Application No. 2009-101998 filed on Apr. 20, 2009 in Japan, the entire contents of which are incorporated herein by reference.

### BACKGROUND OF THE INVENTION

1. Field of the Invention

The present invention relates to a DC/DC converter and a power supply system.

2. Related Art

When a DC/DC converter that functions as a regulator supplies a constant potential to a load circuit (such as DRAM) having a large peak current, a large output capacitor is necessary to suppress a potential fluctuation. When the value of the output capacitor is decreased to reduce an area, it is necessary to enhance response speed of the regulator in order to suppress the potential fluctuation. Therefore, it is necessary to increase a bias current of a comparator in the regulator and a current consumption of a buffer which is supplied with an output signal of the comparator to drive the output transistor in the regulator. However, in such cases, power consumption of the regulator is increased. Particularly, when the load circuit which is driven is in a standby state in which the power consumption is small, the bias current of the comparator in the regulator is large beyond necessity.

For example, JP-A 2006-59440 (KOKAI) discloses a circuit of the DC/DC converter.

### SUMMARY OF THE INVENTION

According to one aspect of the present invention, there is provided a DC/DC converter including: a first regulator supplied with a first reference potential, the first regulator outputting an output potential from an output terminal thereof, the first regulator controlling the output potential so as to be equal to the first reference potential; a second regulator supplied with a second reference potential, the second reference potential being lower than the first reference potential, an output terminal of the second regulator being connected to the output terminal of the first regulator, the second regulator controlling the output potential so as to be equal to the second reference potential; and a first comparator which compares a third reference potential and the output potential, the third reference potential being a potential between the first reference potential and the second reference potential, the first comparator putting the second regulator into an operating state under a first condition in which the output potential is lower than the third reference potential, the first comparator putting the second regulator into a stopped state under a second condition in which the output potential is higher than the third reference potential.

According to another aspect of the present invention, there is provided a DC/DC converter including first to n-th (n is an integer more than one) regulators, wherein the first regulator is supplied with a first reference potential, the first regulator outputs an output potential from an output terminal thereof, and the first regulator controls the output potential so as to be equal to the first reference potential, the k-th (2≦k≦n) regulator is supplied with a k-th reference potential which is lower than the (k−1)-th reference potential, an output terminal of the k-th regulator is connected to an output terminal of the (k−1)-th regulator, and the k-th regulator controls the output potential so as to be equal to the k-th reference potential, the m-th (1≦m≦n−1) regulator puts the (m+1)-th regulator into an operating state when the output potential is lower than the m-th reference potential, and the m-th regulator puts the (m+1)-th regulator into a stopped state when the output potential is higher than the m-th reference potential.

According to still another aspect of the present invention, there is provided a power supply system including: the DC/DC converter of the first aspect; and a capacitor, one end thereof being supplied with the output potential, and the other end thereof being grounded.

### BRIEF DESCRIPTION OF THE DRAWINGS

FIG. 1 is a block diagram showing a power supply system according to a first embodiment of the invention;

FIG. 2 is a circuit diagram showing a circuit that produces a reference potential of the first embodiment of the invention;

FIG. 3 is a circuit diagram showing the power supply system of the first embodiment of the invention;

FIG. 4 is a circuit diagram showing a comparator 32 of the first embodiment of the invention;

FIG. 5 is a waveform chart showing an output potential VOUT and a current consumption in the power supply system of the first embodiment of the invention;

FIG. 6 is a block diagram showing a power supply system according to a second embodiment of the invention;

FIG. 7 is a circuit diagram showing a regulator 10 of the second embodiment of the invention;

FIG. 8 is a circuit diagram showing the power supply system of the second embodiment of the invention;

FIG. 9 is a waveform chart showing an output potential VOUT and a current consumption in the power supply system of the second embodiment of the invention;

FIG. 10 is a circuit diagram showing a power supply system according to a third embodiment of the invention; and

FIG. 11 is a circuit diagram showing a power supply system of a comparative example.

### DETAILED DESCRIPTION OF THE INVENTION

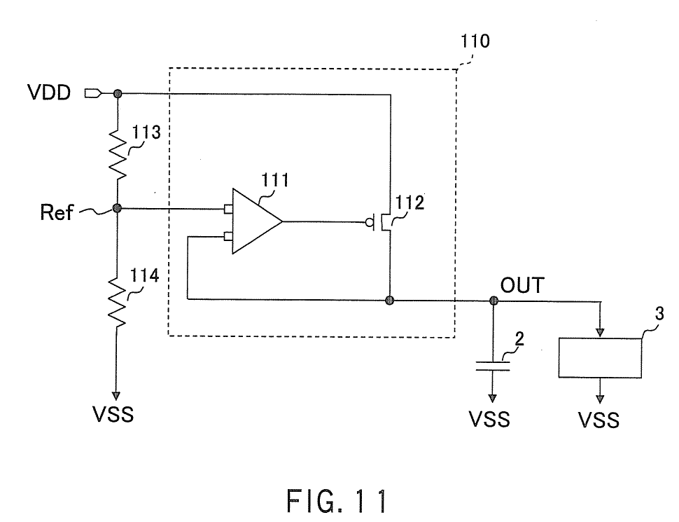

Before describing embodiments of the invention, a power supply system of a comparative example the inventor perceive will be described with reference to FIG. 11.

In the power supply system of the comparative example of FIG. 11, a DC/DC converter 110 outputs an output potential VOUT to a capacitor 2 and a load circuit 3. The DC/DC converter 110 includes a comparator 111 and a PMOS transistor 112. In the comparator 111, a reference potential Ref is input to an inverting input terminal, and the output potential VOUT is input to a non-inverting input terminal. In the PMOS transistor 112, a comparison signal of the comparator 111 is input to a gate, and the output potential VOUT is output from a drain. The reference potential Ref is generated at a connection node of resistors 113 and 114 that are connected in series between an external power-supply potential VDD and a ground potential VSS. The output potential VOUT is controlled so as to be equal to the reference potential Ref. A constant bias current passes the comparator 111 even if the load circuit 3 is in the standby state.

Embodiments of the invention will be described with reference to the drawings. The embodiments will not limit the invention. In the following description, the similar component is designated by the same numeral, and the overlapping description is made if needed.

### First Embodiment

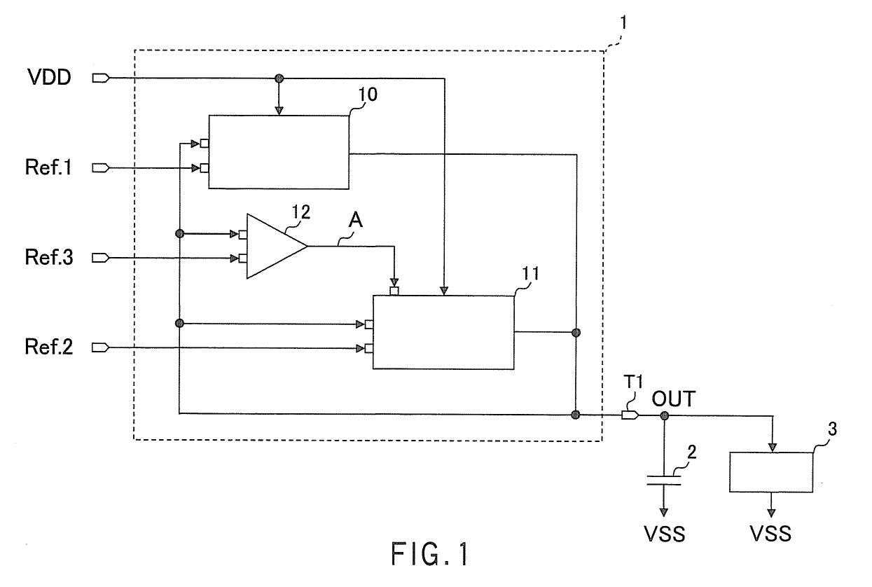

A first embodiment of the invention will be described with reference to FIGS. 1 to 5. One of the features of the first embodiment is that two regulators having different target potentials and different output currents are connected in parallel to supply an electric power to the load circuit, and the regulator having a low target potential and a large output current is controlled so as to be in an operating state or a stopped state according to an output potential.

In the first embodiment, first, a schematic power supply system will be described by a block-level circuit, and next, an element-level circuit configuration will be described more specifically.

FIG. 1 is a block diagram showing a power supply system according to a first embodiment of the invention. The power supply system includes a DC/DC converter 1, a capacitor 2, and a load circuit 3. The DC/DC converter 1 outputs the output potential VOUT from an output terminal T1. The output terminal T1 is connected to one end of the capacitor 2 and one end of the load circuit 3 to which the electric power is supplied. The other end of the capacitor 2 and the other end of the load circuit 3 are connected to the ground potential VSS. The load circuit 3 is an electronic device such as a semiconductor storage device or a mobile device. For example, the current consumption of the load circuit 3 is tens of microamperes in the standby state and tens of milliamperes in the operating state.

The DC/DC converter 1 includes a regulator 10 (first regulator), a regulator 11 (second regulator), and a comparator 12 (first comparator). An output terminal of the regulator 10 is connected to an output terminal of the regulator 11, comparison potential input terminal of regulators 10 and 11, a non-inverting input terminal of the comparator 12, and the output terminal T1 of the DC/DC converter 1.

A reference potential Ref.1 (first reference potential) that functions as the target potential is input to a reference potential input terminal of the regulator 10. A reference potential Ref.2 (second reference potential) that functions as the target potential is input to a reference potential input terminal of the regulator 11. A reference potential Ref.3 (third reference potential) is input to an inverting input terminal of the comparator 12.

The reference potential Ref.1 is higher than the reference potential Ref.2. The reference potential Ref.3 is an intermediate potential between the reference potential Ref.1 and the reference potential Ref.2. For example, the reference potential Ref.1 is higher than the reference potential Ref.3 by about 50 mV, and the reference potential Ref.2 is lower than the reference potential Ref.3 by about 50 mV. The reference potential Ref.3 may be a potential between the reference potential Ref.1 and the reference potential Ref.2.

The regulator 10 has a slow response speed, a small output current (for example, 100 μA), and the small power consumption. The response speed of the regulator 11 is faster than the response speed of the regulator 10, the output current (for example, tens of milliamperes) of the regulator 11 is larger than the output current of the regulator 10, and therefore the power consumption of the regulator 11 is larger than the power consumption of the regulator 10.

The regulator 10 controls the output potential VOUT so as to be substantially equal to the reference potential Ref.1. The regulator 11 controls the output potential VOUT so as to be substantially equal to the reference potential Ref.2.

A comparison signal A output from the comparator 12 is input to an ON/OFF control terminal of the regulator 11. The comparator 12 puts the regulator 11 into an operating state when the output potential VOUT is lower than the reference potential Ref.3, and the comparator 12 puts the regulator 11 into a stopped state when the output potential VOUT is higher than the reference potential Ref.3.

An operation of the power supply system of FIG. 1 will be described below. The output potential VOUT is controlled so as to be substantially equal to one of the reference potentials Ref.1 and Ref.2 according to the power consumption of the load circuit 3.

When the power consumption of the load circuit 3 is large, the output potential VOUT becomes substantially equal to the reference potential Ref.2, and the regulators 10 and 11 supply the electric power to the load circuit 3.

On the other hand, when the load circuit 3 is in the standby state and the like in which the power consumption is small, the regulator 10 performs the control so as to raise the output potential VOUT. Therefore, the output potential VOUT becomes higher than the target potential (reference potential Ref.2) of the regulator 11, and the output potential VOUT becomes substantially equal to the reference potential Ref.1. Accordingly, because the output potential VOUT becomes higher than the reference potential Ref.3, the comparator 12 controls the regulator 11 to be in the stopped state, and therefore the power consumption thereof is decreased.

An example of an element-level circuit configuration in the power supply system of FIG. 1 will specifically be described below.

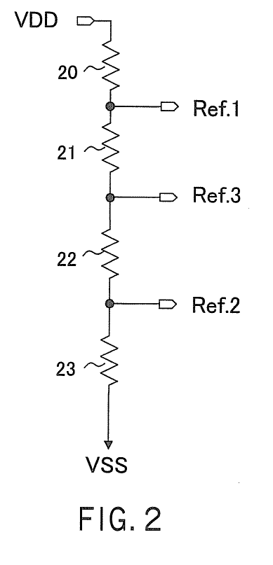

FIG. 2 is a circuit diagram showing a circuit that produces the reference potentials Ref.1 to Ref.3 of the first embodiment.

Resistors 20 to 23 are connected in series between the external power-supply potential VDD and the ground potential VSS. The reference potential Ref.1 is output from the connection node of the resistors 20 and 21, the reference potential Ref.3 is output from the connection node of resistors 21 and 22, and the reference potential Ref.2 is output from the connection node of the resistors 22 and 23.

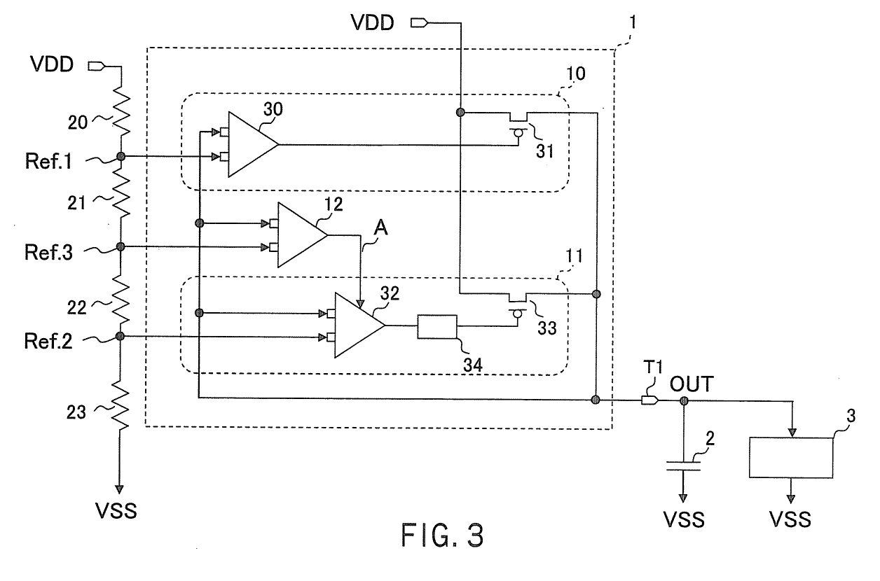

FIG. 3 is a circuit diagram showing the power supply system of the first embodiment. The regulator 10 includes a comparator 30 (second comparator) and a PMOS transistor 31 (first output transistor). In the PMOS transistor 31, a comparison signal of the comparator 30 is input to a gate, the external power-supply potential VDD is input to a source, the output potential VOUT is output from a drain. The regulator 11 includes a comparator 32 (third comparator), a PMOS transistor 33 (second output transistor), and a buffer 34. A comparison signal of the comparator 32 is input to a gate of the PMOS transistor 33 via the buffer 34. The PMOS transistor 33 is larger than the PMOS transistor 31 in dimensions, and the PMOS transistor 33 can output a current larger than a current of the PMOS transistor 31. The buffer 34 is provided to drive the PMOS transistor 33. The comparison signal A output from the comparator 12 is input to an ON/OFF control terminal of the comparator 32. The reference potentials Ref.1 to Ref.3 are supplied from the circuit of FIG. 2. Other configurations are similar to those of the block diagram of FIG. 1.

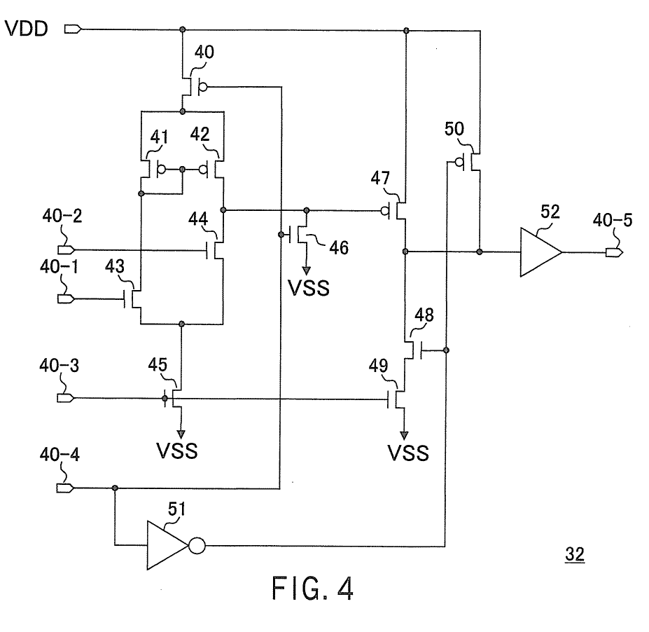

FIG. 4 is a circuit diagram showing the comparator 32 of the first embodiment. A gate of an NMOS transistor 43 is connected to a non-inverting input terminal 40-1. A gate of an NMOS transistor 44 is connected to an inverting input terminal 40-2. Sources of the NMOS transistors 43 and 44 are commonly connected to each other, and are connected to the ground potential VSS via an NMOS transistor 45. A drain of the NMOS transistor 43 is connected to a drain of a PMOS transistor 40 via the PMOS transistor 41. A drain of the NMOS transistor 44 is connected to the drain of the PMOS transistor 40 via the PMOS transistor 42. Gates of the PMOS transistors 41 and 42 are connected to the drain of the NMOS transistor 43. The external power-supply potential VDD is input to the source of the PMOS transistor 40.

A connection node of the PMOS transistor 42 and the NMOS transistor 44 is connected to a gate of a PMOS transistor 47. The external power-supply potential VDD is input to a source of the PMOS transistor 47, and a drain of the PMOS transistor 47 is connected to a drain of an NMOS transistor 49 via an NMOS transistor 48. A source of the NMOS transistor 49 is connected to the ground potential VSS.

The drain of the PMOS transistor 47 is connected to an output terminal 40-5 via a buffer 52. The NMOS transistor 46 is connected between the gate of the PMOS transistor 47 and the ground potential VSS. A PMOS transistor 50 is connected between the drain of the PMOS transistor 47 and the external power-supply potential VDD. An ON/OFF control terminal 40-4 is connected to the gate of the NMOS transistor 46 and the gate of the PMOS transistor 40. The ON/OFF control terminal 40-4 is connected to the gates of the NMOS transistor 48 and PMOS transistor 50 via an inverter 51.

The gates of the NMOS transistors 45 and 49 are connected to the bias input terminal 40-3. A predetermined bias potential is input to the bias input terminal 40-3. The bias input terminal of the comparator 31 is omitted in FIG. 3.

When a high-level signal is input to the ON/OFF control terminal 40-4, the PMOS transistor 40 and the NMOS transistor 48 are put into the off state, and the NMOS transistor 46 and the PMOS transistor 50 are put into the on state. Therefore, the current consumption of the comparator 32 becomes substantial zero, and the comparison signal of the comparator 32 is held on to the high level.

When a low-level signal is input to the ON/OFF control terminal 40-4, the comparator 32 is put into the operating state. The large bias current is passed via the NMOS transistors 45 and 49 such that the comparator 32 can respond to the input signal at high speed.

The comparators 12 and 30 of FIG. 3 have the same circuit configuration as that of FIG. 4, and the comparators 12 and 30 are smaller than the comparator 32 in the bias current. The bias input terminals and ON/OFF control terminals of the comparators 12 and 30 are omitted in FIG. 3.

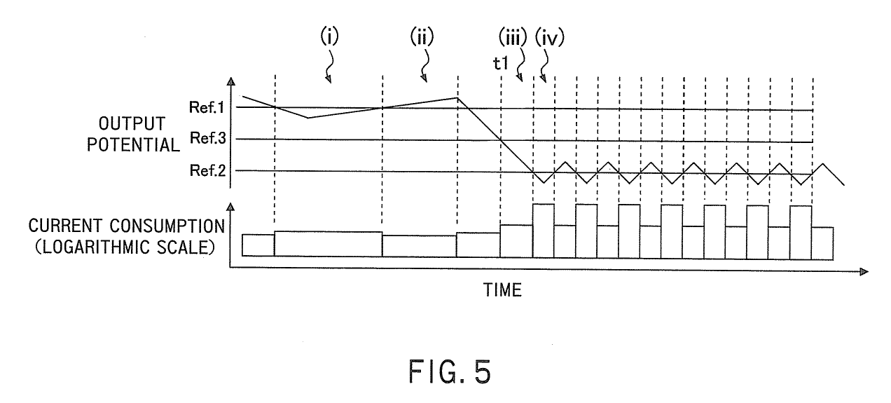

An element-level operation of the power supply system of FIG. 3 will be described with reference to FIG. 5. FIG. 5 is a waveform chart showing an output potential VOUT and a current consumption in the power supply system of FIG. 3. In FIG. 5, a horizontal axis indicates time, and a vertical axis indicates the output potential VOUT and the current consumption. The current consumption is an integral value in each period. The current consumption is expressed in a logarithmic scale. FIG. 5 schematically shows the state in which the output potential VOUT fluctuates near the target potential.

As described above, when the load circuit 3 is in the standby state in which the power consumption is small, the regulator 10 controls the output potential VOUT so as to be substantially equal to the reference potential Ref.1 (periods (i) and (ii)). At this point, the comparison signal A from the comparator 12 is the high level, and the comparator 32 is in the stopped state. At the same time, the gate of the PMOS transistor 33 is the high level, and the PMOS transistor 33 is in the off state. That is, the regulator 11 is in the stopped state. Therefore, the power consumption of the DC/DC converter 1 is decreased by the power consumption of the regulator 11 compared with the case in which the load circuit 3 is in the operating state.

In the period (i), because the output potential VOUT is lower than the reference potential Ref.1, the PMOS transistor 31 is put into the on state. Therefore, the current consumption is the sum of the currents of the comparator 30, PMOS transistor 31, and comparator 12.

In the period (ii), because the output potential VOUT is higher than the reference potential Ref.1, the PMOS transistor 31 is put into the off state. Therefore, the current consumption is the sum of the currents of the comparators 12 and 30.

Then, when the load circuit 3 becomes the operating state to increase the power consumption, the output potential VOUT is decreased. When the output potential VOUT becomes lower than the reference potential Ref.3, the comparison signal A of the comparator 12 is changed from the high level to the low level, and the comparator 32 is put into the operating state (time t1). Because the output potential VOUT is higher than the reference potential Ref.2, the comparison signal of the comparator 32 puts the PMOS transistor 33 into the on state. Therefore, the regulators 10 and 11 supply the electric power to the load circuit 3. Almost all the electric powers are supplied from the regulator 11 having the large output current. The output potential VOUT is controlled so as to become substantially equal to the reference potential Ref.2.

In the period (iii), the current consumption is the sum of the currents of the comparators 12, 30, and 32, the current of the PMOS transistors 31 and 33, and the current of the buffer 34.

In the period (iv), because the output potential VOUT is lower than the reference potential Ref.2, the PMOS transistor 33 is put into the off state. Therefore, the current consumption is the sum of the currents of the comparators 12, 30, and 32, the current of the PMOS transistor 31, and the current of the buffer 34.

As described above, according to the first embodiment, the regulator 10 having the high target potential and the regulator 11 having the low target potential are connected in parallel to supply the electric power to the load circuit 3. Therefore, the output potential VOUT is controlled to the low target potential when the load circuit 3 has the large power consumption, and the output potential VOUT is controlled to the high target potential when the load circuit 3 has the small power consumption. Accordingly, when the load circuit 3 has the small power consumption, the regulator 11 can be put into the stopped state based on the output potential VOUT to reduce the power consumption of the DC/DC converter 1 and power supply system. When the load circuit 3 has the large power consumption, the regulator 11 can be put into the operating state based on the output potential VOUT to enhance the response speeds of the DC/DC converter 1 and power supply system, thereby suppressing the potential fluctuation of the output potential VOUT.

In addition, according to the first embodiment, because the power consumption can be decreased in the standby state, the average value of the power consumption of the DC/DC converter 1 can be equalized to that of the conventional art even if the power consumption of the regulator 11 is increased. In such cases, the response speed of the regulator 11 is further enhanced, so that the capacitor 2 can further be reduced.

The regulators 10 and 11 may be identical to each other in the output current and the response speed. In such cases, when the load circuit 3 has the small power consumption, the regulator 11 having the low target potential can also be put into the stopped state. Therefore, the power consumption can be decreased.

The plural regulators having different target potentials may be connected in parallel, and the plural comparators may control the operations of the regulators.

### Second Embodiment

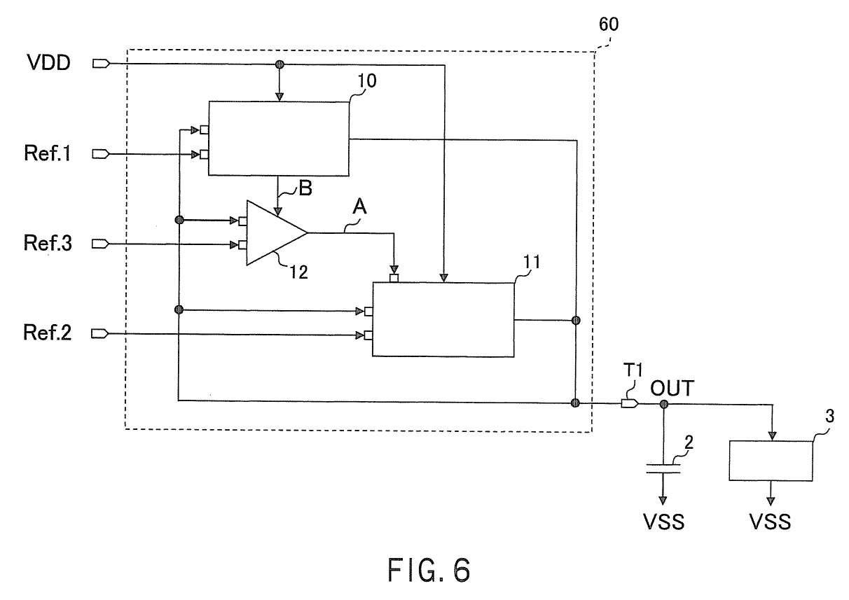

A second embodiment of the invention will be described with reference to FIGS. 6 to 9. One of the features of the second embodiment is that the comparator 12 of the first embodiment is controlled so as to be in the operating state or stopped state according to the output potential VOUT.

FIG. 6 is a block diagram showing a power supply system according to the second embodiment of the invention. In the power supply system of the second embodiment, the comparison signal B from regulator 10 is input to the ON/OFF control terminal of the comparator 12 of the DC/DC converter 60. Other configurations are similar to those of the first embodiment of FIG. 1.

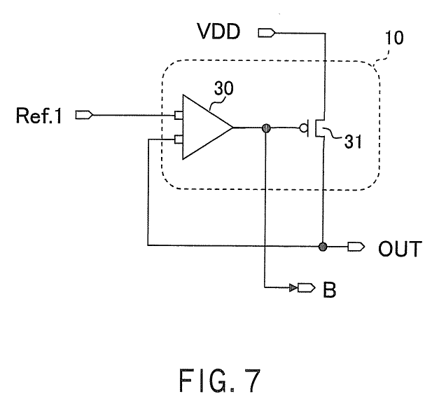

FIG. 7 is a circuit diagram showing the regulator 10 of the second embodiment. The comparator 30 outputs the comparison signal B to the gate of the PMOS transistor 31.

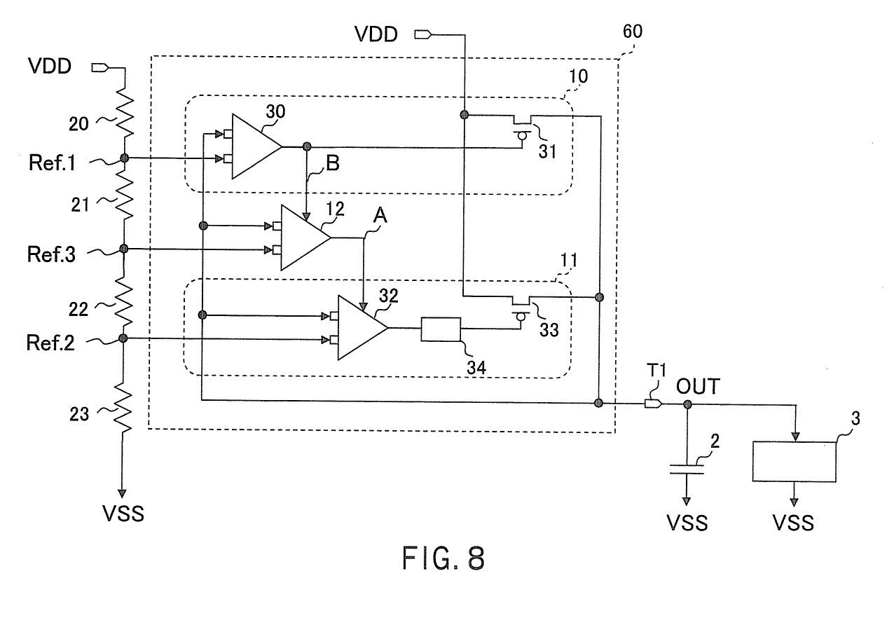

An example of the specific circuit configuration of the power supply system of FIG. 6 will be described below. FIG. 8 is a circuit diagram showing the power supply system of the second embodiment. As described above, the comparison signal B output from the comparator 30 of the regulator 10 is input to the ON/OFF control terminal of the comparator 12.

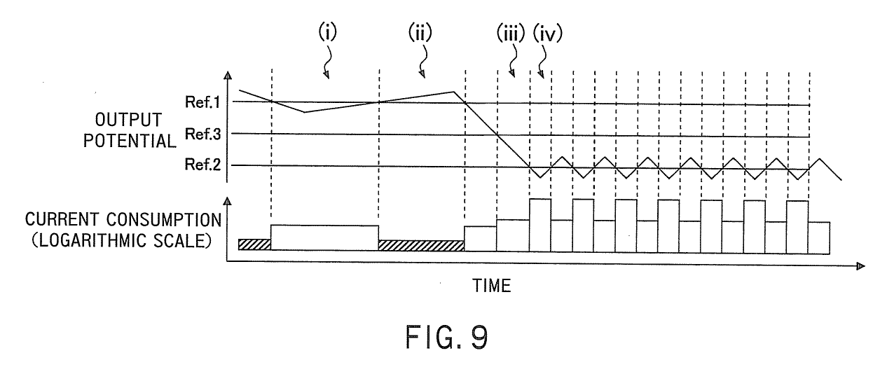

An operation of the power supply system of FIG. 8 will be described below. FIG. 9 is a waveform chart showing an output potential VOUT and a current consumption in the power supply system of FIG. 8.

The comparator 12 is controlled so as to be in the operating state or the stopped state by the comparison signal B supplied from the comparator 30 of the regulator 10.

In the period (i), because the output potential VOUT at the DC/DC converter 60 is lower than the reference potential Ref.1, the comparison signal B of the comparator 30 becomes the low level, and therefore the comparator 12 is in the operating state. That is, the power supply system is operated in the same manner as the first embodiment.

In the period (ii), because the output potential VOUT is higher than the reference potential Ref.1, the comparison signal B of the comparator 30 becomes the high level, and therefore the comparator 12 is in the stopped state. Consequently, in the period (ii), the current consumption is further reduced compared with the first embodiment.

In the periods (iii) and (iv), the power supply system is operated in the same manner as the first embodiment.

As described above, according to the second embodiment, the comparator 12 is also controlled so as to be in the operating state or the stopped state according to the output potential VOUT. When the output potential VOUT is higher than the reference potential Ref.1 while the load circuit 3 is in the low power consumption state, the power consumption of the DC/DC converter 60 and power supply system can further be decreased by the power consumption of the comparator 12 compared with the first embodiment.

### Third Embodiment

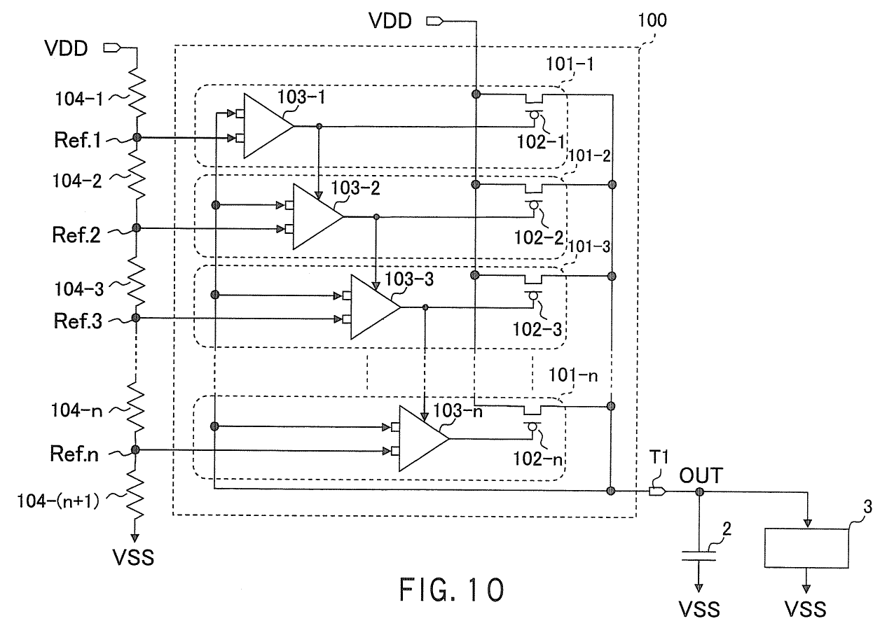

A third embodiment of the invention will be described with reference to FIG. 10. The third embodiment differs from the first embodiment in the following point. That is, plural regulators are connected in parallel, each of the regulators having different target potentials, and each of the regulators is controlled so as to be in the operating state or the stopped state according to the output potential.

FIG. 10 is a circuit diagram showing a power supply system according to a third embodiment of the invention. A DC/DC converter 100 includes n (n is an integer more than one) regulators 101-1 to 101-n. The regulator 101-1 (first regulator) includes a PMOS transistor 102-1 (first output transistor) and a comparator 103-1 (first comparator). Similarly, the regulator 101-n (n-th regulator) includes a PMOS transistor 102-n (n-th output transistor) and a comparator 103-n (n-th comparator). Output terminals of the regulators 101-1 to 101-n are commonly connected to the output terminal T1 and non-inverting input terminals of the comparators 103-1 to 103-n. The output terminal of the m-th (1≦m≦n−1) comparator 103-m is connected to the ON/OFF control terminal of the (m+1)-th comparator 103-(m+1).

Resistors 104-1 to 104-(n+1) are connected in series between the external power-supply potential VDD and the ground potential VSS. Each reference potential Ref.1 (first reference potential) to Ref.n (n-th reference potential) is generated at each connection node of the resistors. Each reference potential Ref.1 to Ref.n is input to each inverting input terminal of the comparators 103-1 to 103-n.

The response speed of the m-th regulator 101-m is slower than that of the (m+1)-th regulator 101-(m+1), the output current of the m-th regulator 101-m is smaller than that of the (m+1)-th regulator 101-(m+1), and the power consumption of the m-th regulator 101-m is smaller than that of the (m+1)-th regulator 101-(m+1).

The first reference potential Ref.1 that functions as the target potential is input to the first regulator 101-1, and the first regulator 101-1 controls the output potential VOUT so as to be substantially equal to the first reference potential Ref.1. The k-th reference potential Ref.k that functions as the target potential is input to the k-th (2≦k≦n) regulator 101-k. The k-th reference potential Ref.k is lower than the (k−1)-th reference potential Ref.(k−1). The output terminal of the k-th regulator 101-k is connected to the output terminal of the (k−1)-th regulator 101-(k−1). The k-th regulator 101-k controls the output potential VOUT so as to be substantially equal to the k-th reference potential Ref.k.

In the circuit configuration of FIG. 10, the output potential VOUT is controlled so as to be substantially equal to one of the reference potentials Ref.1 to Ref.n according to the power consumption of the load circuit 3. The case in which the output potential VOUT is controlled so as to be substantially equal to the reference potential Ref.2 will be described by way of example. When the output potential VOUT fluctuates in the state in which the output potential VOUT is higher than the reference potential Ref.2 while being lower than the reference potential Ref.1, the comparison signals of the comparators 103-2 to 103-n become the high level. Therefore, the comparators 103-3 to 103-n become the stopped state and the PMOS transistors 102-3 to 102-n also become the off state. Accordingly, the regulators 101-3 to 101-n become the stopped state to be able to decrease the power consumption.

That is, the m-th regulator 101-m puts the (m+1)-th regulator 101-(m+1) into the operating state when the output potential VOUT is lower than the m-th reference potential Ref.m, and the m-th regulator 101-m puts the (m+1)-th regulator 101-(m+1) into the stopped state when the output potential VOUT is higher than the m-th reference potential Ref.m.

As described above, according to the third embodiment, plural regulators 101-1 to 101-n whose target potentials are different from one another are connected in parallel, and the regulators 101-1 to 101-n are sequentially controlled so as to be in the operating state or stopped state according to the output potential VOUT. Therefore, compared with the first embodiment, the power consumption of the DC/DC converter 100 can more finely be adjust according to the power consumption of the load circuit 3. Consequently, the DC/DC converter 100 and the power supply system having the small power consumption can be realized.

In addition, the regulators 101-1 to 101-n may be equal to one another in the output current and the response speed. In such cases, the power consumption of the DC/DC converter 100 can also be adjusted according to the power consumption of the load circuit 3.

Although the embodiments of the present invention have been described in detail, the specific configuration is not limited to the above embodiments, but various modifications can be made without departing from the scope of the invention.

1. A DC/DC converter comprising:
a first regulator supplied with a first reference potential, the first regulator outputting an output potential from an output terminal thereof, the first regulator controlling the output potential so as to be equal to the first reference potential;
a second regulator supplied with a second reference potential, the second reference potential being lower than the first reference potential, an output terminal of the second regulator being connected to the output terminal of the first regulator, the second regulator controlling the output potential so as to be equal to the second reference potential; and
a first comparator which compares a third reference potential and the output potential, the third reference potential being a potential between the first reference potential and the second reference potential, the first comparator putting the second regulator into an operating state under a first condition in which the output potential is lower than the third reference potential, the first comparator putting the second regulator into a stopped state under a second condition in which the output potential is higher than the third reference potential.

2. The DC/DC converter according to claim 1, wherein the second regulator is larger than the first regulator in an output current, and the second regulator is faster than the first regulator in a response speed.

3. The DC/DC converter according to claim 1, wherein the third reference potential is an intermediate potential between the first reference potential and the second reference potential.

4. The DC/DC converter according to claim 1, wherein the first regulator comprises:
a first output transistor, one end thereof being supplied with a power-supply potential, and the other end thereof outputting the output potential; and
a second comparator which compares the first reference potential and the output potential to output a comparison result to a control terminal of the first output transistor,
the second regulator comprises:
a second output transistor, one end thereof being supplied with the power-supply potential, and the other end thereof outputting the output potential; and
a third comparator which compares the first reference potential and the output potential to output a comparison result to a control terminal of the second output transistor,
the first comparator puts the third comparator into the operating state under the first condition, the first comparator puts the third comparator into the stopped state under the second condition, and
the third comparator puts the second output transistor into an off state when the third comparator is in the stopped state.

5. The DC/DC converter according to claim 4, wherein the first and second output transistors are a positive-channel metal-oxide-semiconductor field-effect transistor (P-type MOS transistor).

6. The DC/DC converter according to claim 4, wherein the second output transistor can output a current which is larger than a current of the first output transistor,
the third comparator is larger than the second comparator in a bias current, and the third comparator is faster than the second comparator in a response speed.

7. The DC/DC converter according to claim 6, wherein a buffer is connected between an output terminal of the third comparator and the control terminal of the second output transistor, and the buffer drives the second output transistor.

8. The DC/DC converter according to claim 1, wherein the first reference potential, the second reference potential, and the third reference potential are generated by resistors, and the resistors are connected between a power-supply potential and a ground potential.

9. The DC/DC converter according to claim 1, wherein the first regulator puts the first comparator into the operating state when the output potential is lower than the first reference potential, and
the first regulator puts the first comparator into the stopped state when the output potential is higher than the first reference potential.

10. The DC/DC converter according to claim 9, wherein the first regulator comprises:
a first output transistor, one end thereof being supplied with a power-supply potential, and the other end thereof outputting the output potential; and
a second comparator which compares the first reference potential and the output potential to output a comparison result to a control terminal of the first output transistor and an ON/OFF control terminal of the first comparator.

11. The DC/DC converter according to claim 10, wherein the second regulator comprises:
a second output transistor, one end thereof being supplied with the power-supply potential, and the other end thereof outputting the output potential; and
a third comparator which compares the first reference potential and the output potential to output a comparison result to a control terminal of the second output transistor,
the first comparator puts the third comparator into the operating state under the first condition, the first comparator puts the third comparator into the stopped state under the second condition, and
the third comparator puts the second output transistor into an off state when the third comparator is in the stopped state.

12. The DC/DC converter according to claim 11, wherein the first and second output transistors are a P-type MOS transistor.

13. The DC/DC converter according to claim 11, wherein the second output transistor can output a current which is larger than a current of the first output transistor,
the third comparator is larger than the second comparator in a bias current, and the third comparator is faster than the second comparator in a response speed.

14. The DC/DC converter according to claim 13, wherein a buffer is connected between an output terminal of the third comparator and the control terminal of the second output transistor, and the buffer drives the second output transistor.

15. A DC/DC converter comprising first to n-th (n is an integer more than one) regulators,
wherein the first regulator is supplied with a first reference potential, the first regulator outputs an output potential from an output terminal thereof, and the first regulator controls the output potential so as to be equal to the first reference potential,
the k-th (2≦k≦n) regulator is supplied with a k-th reference potential which is lower than the (k−1)-th reference potential, an output terminal of the k-th regulator is connected to an output terminal of the (k−1)-th regulator, and the k-th regulator controls the output potential so as to be equal to the k-th reference potential,
the m-th (1≦m≦n−1) regulator puts the (m+1)-th regulator into an operating state when the output potential is lower than the m-th reference potential, and the m-th regulator puts the (m+1)-th regulator into a stopped state when the output potential is higher than the m-th reference potential.

16. The DC/DC converter according to claim 15, wherein the m-th regulator is smaller than the (m+1)-th regulator in an output current, and the m-th regulator is slower than the (m+1)-th regulator in a response speed.

17. The DC/DC converter according to claim 15, wherein the m-th regulator comprises:
a m-th output transistor, one end thereof being supplied with a power-supply potential, and the other end thereof outputting the output potential; and
a m-th comparator which compares the m-th reference potential and the output potential to output a comparison result to a control terminal of the m-th output transistor,
the n-th regulator comprises:
an n-th output transistor, one end thereof being supplied with the power-supply potential, and the other end thereof outputting the output potential; and
an n-th comparator which compares the n-th reference potential and the output potential to output a comparison result to a control terminal of the n-th output transistor,
the m-th comparator outputs the comparison result to an ON/OFF control terminal of the (m+1)-th comparator,
the m-th comparator puts the (m+1)-th comparator into the operating state when the output potential is lower than the m-th reference potential,
the m-th comparator puts the (m+1)-th comparator into the stopped state when the output potential is higher than the m-th reference potential, and
the (m+1)-th comparator puts the (m+1)-th output transistor into an off state when the (m+1)-th comparator is in the stopped state.

18. The DC/DC converter according to claim 17, wherein the first to n-th output transistors are a P-type MOS transistor.

19. The DC/DC converter according to claim 15, wherein the first to n-th reference potentials are generated by resistors, and the resistors are connected between a power-supply potential and a ground potential.

20. A power supply system comprising:
the DC/DC converter according to claim 1; and
a capacitor, one end thereof being supplied with the output potential, and the other end thereof being grounded.
